(19) United States
(12) Patent Application Publication
(10) Pub. No.: US 2009/0328198 A1
(43) Pub. Date: Dec. 31, 2009

(54) SECURE PASSWORD ORGANIZER

(75) Inventor: Daniel Rothman, Fountain Valley, CA (US)

Correspondence Address: NovaTech IP Law, 1001 Avenue Pico, Suite C500, San Clemente, CA, 92673, US

(73) Assignee: ATEK, INC., Santa Ana, CA (US)

(21) Appl. No.: 12/163,988

(22) Filed: Jun. 27, 2008

(51) Int. Cl. H04L 9/32; G06F 21/00

(52) U.S. Cl. 726/18

(57) ABSTRACT

A computer-readable stored median has stored thereupon a program for performing a method of generating, storing, accessing, retrieving and displaying a plurality of records such as in an electronic device. The electronic device may include a data entry mechanism and a keyboard and may further include a processor, a memory, and a display. The method compromises the steps of generating and saving a master passcode in the memory and generating a record such as an account identification, a user ID and a password, and saving the record in the memory. The method further comprises the steps of generating a user ID for storage in the memory and generating and storing the password corresponding to the user ID in the memory. Access to the memory is provided by entering the master passcode for retrieval of the records.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND

The present invention relates generally to information systems and, more particularly, to a uniquely configured system and method for managing access to a plurality of passwords as may be used to restrict access to a variety of systems. Advantageously, the present invention provides a method for creating, storing, accessing, retrieving and displaying a plurality of records wherein the records may include an account identification, a user ID and a password associated with the account identification and the user ID and wherein account identifications, user IDs and passwords are accessible by use of a single master passcode.

User IDs and passwords are commonly used tools for protecting access to restricted data. Such data may include the personal information of an individual such as financial account information or medical history information. As is well known, such information is typically stored in various systems such as on websites and in various computer systems. Passwords provide a common means for user authentication prior to allowing access to systems and accounts in order to prevent misuse of such information.

For example, identity theft is a growing problem and is due in large part to the ever increasing amounts of information that are now stored in various internet-accessible accounts. Common forms of identity theft include the unauthorized access and misuse of credit card information in order to obtain goods and services by someone impersonating the account holder. Passwords are commonly used to guard against unauthorized access to information. Such information can include website names and/or addresses and associated account information, bank account numbers, credit card information such as credit card numbers, three and four digit security codes for credit cards, stock brokerage account numbers, insurance policy numbers.

Other information that may be subject to unauthorized access may include computer or application names and associated files and information, passport and drivers license numbers, alarm codes, membership program information such as airline frequent flyer program account numbers, hotel and car rental loyalty numbers, bank PIN codes, and web domain and hosting account access information. It is also sometimes desirable to have quick and easy access to certain types of information such as alarm company telephone numbers, expiration dates for driver's license and passport numbers as well as customer service telephone numbers.

As the majority of sensitive information is increasingly stored in computer systems, many individuals have multiple accounts requiring user IDs and passwords which correspond to each account. Ideally, a different password is used with a different account in order to help avoid the above-mentioned problem of unauthorized access to the account should an unauthorized person discover the particular user ID and password for a single account. The large number of user IDs and corresponding passwords increases complexity and presents problems associated with convenience and security of the accounts.

As a result, many users develop a tendency to use simple passwords or even the same password for different accounts. In this manner, instead of memorizing a plurality of different passwords corresponding to different user IDs, it is only necessary to memorize a single or a few passwords. Unfortunately, the practice of utilizing an easy-to-guess password or the same password for different accounts may compromise the security of any one of the accounts should an unauthorized person discover the identity of a password.

In an attempt to avoid the security risks with using the same password for different accounts, some users may use different passwords for different accounts but may generate hand written notes, sometimes on a single piece of paper, listing each user ID and password associated with an account. Unfortunately, such practice poses a risk that the paper may become lost or misplaced and/or found by and/or stolen by someone who may misuse the information. Alternatively, some users generate a computer record of accounts, user IDs and/or passwords and may attempt to hide the information by storing it in a hidden or misdescriptive folder or file. This poses a risk that someone with unauthorized access to the computer, such as a hacker, may easily get at such information through the use of increasingly sophisticated prying and password-guessing technology.

Complicating the problem, some online accounts require that users change their passwords on a periodic basis such as on a monthly basis which forces the user to come up with even more passwords if they want to use unique passwords for all their accounts, thus exacerbating the problem of managing and remembering all those passwords. For diligent individuals, the use of hard-to-guess passwords often results in the user being unable to recall the complex password and then wasting time trying to remember or try passwords, or requiring that the user request a password reminder or reset during which time the user may be unable to access their accounts.

As can be seen, there exists a need in the art for a system and method for storing multiple records of different passwords for different accounts. More particularly, there exists a need in the art for a system and method for storing a plurality of records such as an account identification along with corresponding login or authentication information such as a user ID and password. In addition, there exists a need in the art for a system and method for storing a plurality of records wherein the records are conveniently stored and accessible in a single location and which allows for the use of hard-to-guess or complex passwords thereby minimizing the risk that information may be accessed by an unauthorized user.

### BRIEF SUMMARY

These and other needs associated with devices for storing and accessing multiple records are specifically addressed and alleviated by the present invention which, in various aspects, comprises a system and method for creating, storing, accessing, retrieving and displaying a plurality of records. The system may be operated via a computer-readable storage median having stored thereon a program for performing the steps of creating, storing, accessing, retrieving and displaying the records in an electronic device. The electronic device may include a data entry mechanism such as a keypad having a plurality of pushbuttons.

The electronic device may further include a processor, an accessible memory and a display. The program is specifically adapted for creating a master passcode to allow access to the records stored in the electronic device. The records may comprise at least one of an account identification, a user ID and a password. The account identification may comprise a variety of different types of information such as bank names, website names and/or addresses/URLs. User IDs and/or passwords may comprise website logins, computer logins, bank ATM logins, and cell phone (PIN) codes.

The program is specifically adapted to allow for the creation of a user ID corresponding to an account identification. The user ID may be one or more preferred user IDs which may be stored in the electronic device for convenient retrieval and inputting when setting up new records and which may be used as is or which may be edited to generate a derived user ID for different accounts. In addition, the user ID may be generated manually as a manual user ID.

The system and method may further comprise creating a password and storing the password corresponding to one of the user IDs. The password may be generated in a random mode, in a manual mode or in a derived mode. The password may be generated in the random mode using a random password button which may preferably be included with the keypad of the electronic device.

The electronic device is specifically adapted to prevent unauthorized access to various types of personal information of the user by requiring a numeric master passcode in a preferred embodiment. The master passcode allows for access to the records which are stored in the electronic device in an encrypted format in a preferred embodiment. Entry of the master passcode decrypts and allows access to the records. Advantageously, the master passcode reduces the need to memorize multiple passwords and thereby avoids or reduces the risk of forgetting such passwords. Furthermore, the master passcode reduces the security risk posed by using the same passwords repetitively. In this regard, the master passcode provides a convenient means for securely storing, accessing, and retrieving multiple passwords without resorting to storing such passwords on paper or in an otherwise insecure manner.

The features, functions, and advantages that have been discussed can be achieved independently in various embodiments of the present invention or may be combined in yet other embodiments, further details of which can be seen with reference to the following description and figures below.

In one embodiment the device might be configured as a handheld device to facilitate portability such that the device may be used wherever and whenever access to the information contained therein is needed. Furthermore, the device may be a handheld device without requiring any type of external electronic interface such as to a computer, storage medium, or display system such that the device may be used wherever and whenever access to the information contained therein is needed and such that the possibility of hacking into the device via such an interface is removed.

### BRIEF DESCRIPTION OF THE DRAWINGS

These and other features of the present invention will become more apparent upon reference to the drawings wherein like numbers refer to like parts there throughout and wherein:

FIG. 1 is a plan view of an electronic device in one embodiment such as may be used for creating, storing, accessing, retrieving and displaying a plurality of records by using a single master passcode;

FIG. 2 is a side view of the electronic device illustrated in FIG. 1;

FIG. 3 is a back view of the electronic organizer illustrated in FIG. 1 and further illustrating a removable battery tray for allowing access to a battery for powering the electronic device;

FIG. 4 is a planned view of the electronic organizer with a key pad removed illustrating an arrangement of internal components contained within a housing of the electronic device; and

FIG. 5 is a flow chart illustrating a method of creating, storing, accessing, retrieving and displaying a plurality of records using a single master password.

### DETAILED DESCRIPTION

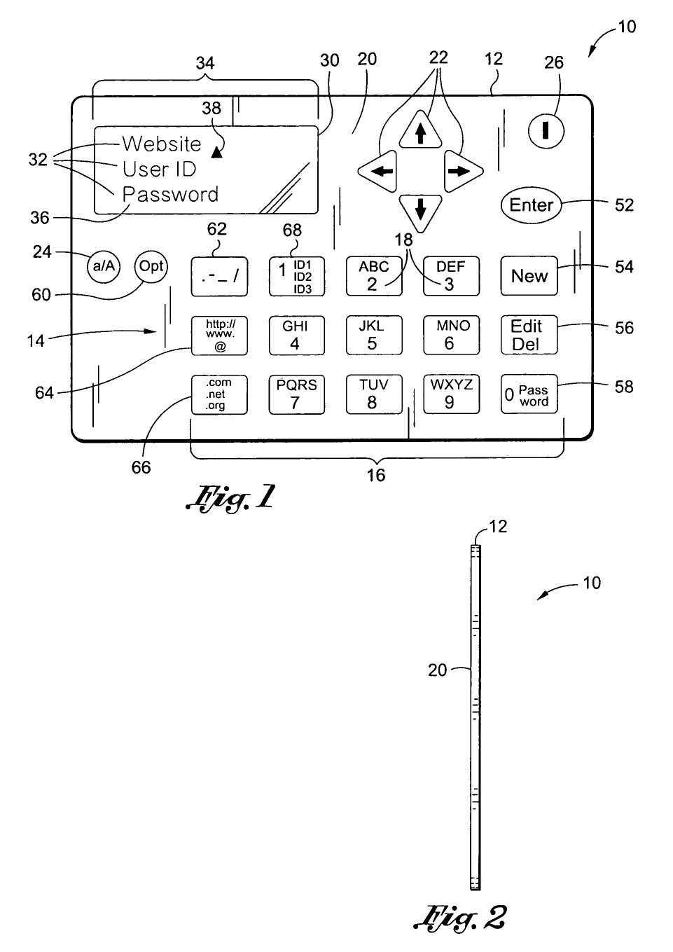

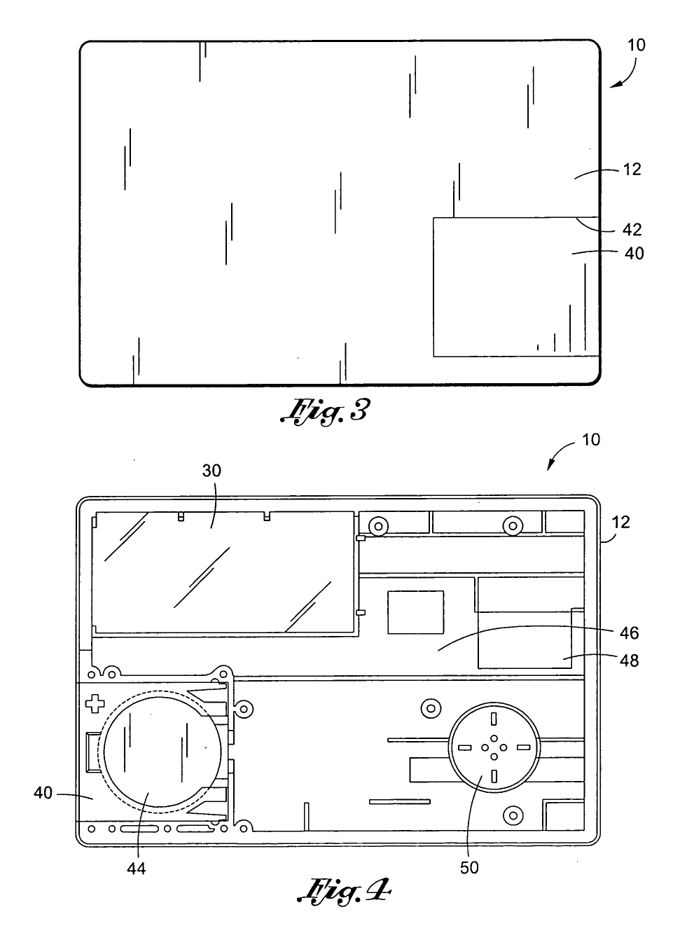

Referring now to the drawings wherein the showings are for purposes of illustrating preferred embodiments of the present invention and not for purposes of limiting the same, FIGS. 1-4 illustrate an electronic device 10 such as an organizer for creating and storing a plurality of records 34. As will be appreciated upon reference to the description below, the electronic device 10 is specifically adapted for securely storing a plurality of records 34 such as user IDs and passwords such as for websites and for computer log-ins and other information.

The records 34 stored in the electronic device 10 may also comprise a variety of different types of records 34 such as automatic teller machine (ATM) card number PIN codes, cellular telephone identification (PIN) codes, credit card numbers, expiration dates and security codes, alarm codes and other sensitive information. In addition, the electronic device 10 and system described herein may also be used to store less sensitive information such as membership program numbers including airline frequent flyer program numbers, hotel and car rental loyalty program numbers and any other type of information which a user desires to maintain in a secure manner or which the user desires to quickly and/or conveniently access.

The electronic device 10 provides a system and method by which the above-described information may be stored and accessed in a secure manner by utilizing a single numeric master passcode. The system and method by which the electronic device 10 operates allows for storage of the records 34 in encrypted format in the electronic device 10. The master passcode provides a means for decrypting and allowing access to such records 34 (i.e., account identifications, user IDs and passwords and/or other information) that are stored in the electronic device 10. In one embodiment, the electronic device 10 stores the information in encrypted format using any one of a variety of available encryption formats such as the advanced encryption standard (AES).

The electronic device 10 and system upon which it operates allows a user to conveniently change passwords regularly as recommended by password experts. Furthermore, the electronic device 10 and system upon which it operates allows for the use of a random mixture of numbers, upper case letters, lower case letters and various special characters such as symbols and punctuation marks in order to further provide the user with more complex passwords that may be more resistant to hacking.

In one embodiment, the present invention may comprise a computer program for creating a master passcode and for creating the plurality of records 34. As was indicated above, each record 34 may comprise any number of different entries and may include at least one of the following: an account identification, a user ID and a password. Advantageously, the program may be configured to allow for creation of the password in either a random mode, in a manual mode or in a derived mode, as will be described in greater detail below. The system may include a data entry mechanism 14, an accessible memory and a display 30. The data entry mechanism 14 may be configured in a wide variety of forms. For example, FIG. 1 illustrates a keypad 16 comprising a plurality of pushbuttons 18 which may be laid out in any suitable manner. In FIG. 1, the keypad 16 arrangement comprises the numerals zero (“0”) through nine (“9”) as well as additional pushbuttons 18 to facilitate entry and editing of the records 34.

A plurality of arrow (e.g., up, down, left, right arrow) buttons 22 are shown disposed adjacent the display 30. As will be described in greater detail below, the arrow buttons 22 are used to manipulate data entry into the electronic device 10. An “on/off” button 26 may be provided with the electronic device 10 as illustrated in the upper right hand corner. Further included in the keypad 16 may be an “enter” button 52, a “new” button 54, an “edit/delete” button 56 and a “random password” button 58 disposed along the right hand side of the electronic device 10. Arranged on the left hand side of the numeric keypad 16 pushbuttons 18 are an “alphanumeric” shift button 24, an “options” button 60, a “special characters” button 62, a “web/e-mail” button 64, and a “domain extension” button 66. The operation of each of these pushbuttons will be described in detail below.

The electronic device 10 and system upon which it operates further includes the memory which is configured for storing the plurality of records 34. As was earlier mentioned, the records 34 are accessible only after entry of the master passcode. The master passcode is generated upon initial setup and may be entered each time access to the records 34 is desired. In one embodiment, the master passcode may be revised or edited.

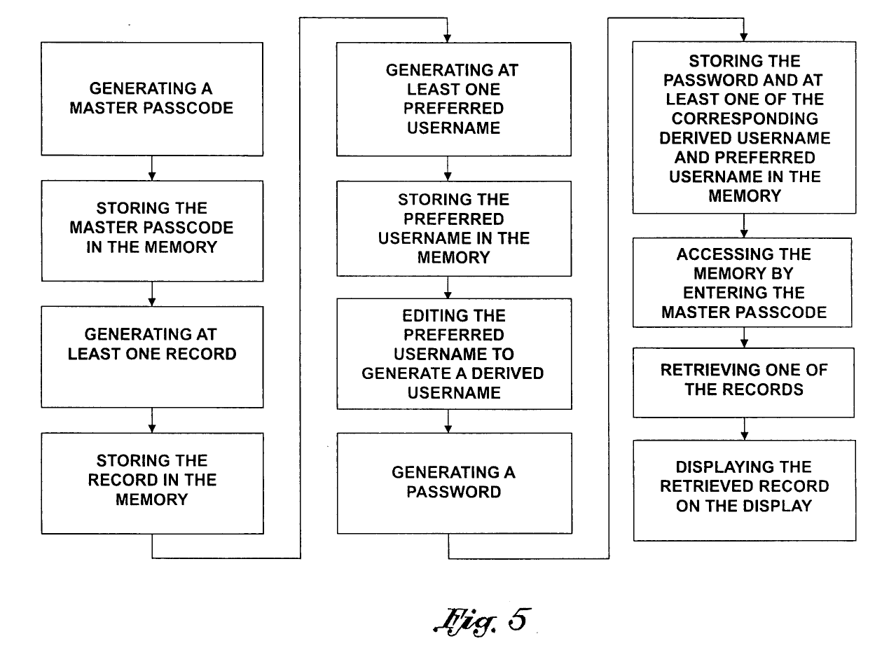

Referring briefly to FIG. 4, the memory may be integrated into a processor 48 such as a microprocessor 48 as is known in the art. The processor 48 may be contained within a housing 12 of the electronic device 10 and, optionally, may be integrated into a circuit board 46 also contained therewithin. The display 30 is electrically connected to the processor 48 which may be powered by a commonly-available battery 44 such as a coin cell battery 44 although the processor 48 may be powered by alternative energy sources such as solar cells. The battery 44 may be mounted in a battery tray 40 which is slidably or removably mounted or disposed within a slot 42 of the housing 12. The processor 48 and/or battery 44 are preferably configured such that no loss of data occurs when the battery 44 is removed from the electronic device 10.

The electronic device 10 may further include a speaker 50 which is preferably operative to generate an audible signal or sound which corresponds to activation of at least one of the pushbuttons 18 of the keyboard 16. In this regard, the audible signal or sound generated during activation of pushing of the various pushbuttons 18 provides feedback for the user to indicate that the pushbutton has been successfully pushed or activated.

In one embodiment, the volume level of the audible sound generated by activation of the pushbuttons 18 can be changed by depressing the “options” button 60 a number of times to scroll through a number of different options to arrive at an option that allows for changing the volume. The volume setting can then be changed by depressing one of the left or right arrow buttons 22 to change from a current sound level to a different sound level. The user can then depress the “enter” button 52 to save the setting.

For example, upon setup of the electronic device, a user may change from a default “medium” sound level to an “off,” “low,” or “high” setting using the left or right arrow buttons 22. The setting may be saved by depressing the “enter” pushbutton 18. It should be noted that the above described process for changing the sound level of the electronic device 10 is an exemplary process only and is not to be construed as limiting the use of alternative processes for changing the sound level of the electronic device 10.

Referring to FIG. 4, the system includes the display 30 for displaying records 34 upon entry of the master passcode and manipulation of the various pushbuttons 18 on the keypad 16. Although illustrated as being disposed or located on an upper left hand side of the electronic device 10, the display 30 may be disposed at any location. The display 30 is preferably a liquid crystal display (“LCD”). However, it is contemplated that the display 30 may be provided in other configurations and in any suitable shape and size.

As was indicated above, the system and/or electronic device 10 upon which the program operates is configured to allow the user to create the master passcode. The master passcode may be entered each time access to the records 34 is desired. The records 34 may comprise any number of different strings 32 displayed on the display 30. The program is operative to decrypt the records 34 and allow access to the records 34 upon entry of the master passcode. The program is further operative to cause the display 30 to retrieve and display the records 34 after successful entry of the master passcode.

As was indicated above, the electronic device 10 may include the processor 48 which is preferably adapted to operate using any number of suitable encryption standards such as the advanced encryption standard (AES) algorithm. In this manner, the program and/or electronic device 10 upon which the program operates is operative to store the records 34 in the memory in encrypted format. The processor 48 is further operative to decrypt and allow access to the records 34 for display upon successful entry of the master passcode into the processor 48.

Referring to FIG. 1, shown is the display 30 which preferably includes three lines or strings 32 of characters. The set of lines or strings 32 comprise the record 34 which, as was indicated earlier, may comprise a website (or non-website) name and/or address or other alternative account identifications comprising alphanumeric characters 36. The account identification may be displayed on the first string 32 or line of characters. A second line or string 32 may include or comprise the user ID. The password may be displayed on the third line or string 32. It should be noted that although the display 30 includes three vertically stacked strings 32 or lines, any number may be provided and in any arrangement other than the vertically stacked arrangement. The strings 32 are made up of a plurality of alphanumeric characters 36 which are entered using the pushbuttons 18 of the keypad 16.

Upon activating the electronic device by depressing the “on/off” button 26, the master passcode may be entered starting at a blinking cursor 38 located on the third line which allows the user to enter an 8-15 digit number. In a preferred embodiment, the master passcode may comprise of numbers only although it is contemplated that the electronic device 10 may be configured to allow for entry of alphabetical characters. In one embodiment, the electronic device 10 may be configured such that the built-in alphanumeric keypad 16 inputs letters and numbers rather than just numbers. In another embodiment, the electronic device 10 may optionally include an alphabetic keypad which may be separate from a numeric keypad.

The master passcode is entered every time access to the records 34 is desired. For the purpose of maximizing both randomness and ease of memorization, the master passcode may correspond to a random “passphrase” such as a made-up sentence wherein the first letter of each word of the passphrase corresponds to the numbers of the master passcode. The user enters the master passcode by depressing the alphanumeric pushbutton 18 having the number that corresponds to the first letter of the word of the passphrase.

When entering the master passcode during the initial setup, the third line may be comprised of a series of asterisks or other characters to mask the identity of the master passcode. A confirmation of the master passcode may be required during the initial setup of the electronic organizer by depressing the enter button 52. The electronic device 10 may be configured to automatically deactivate (i.e., turn off) after a preprogrammed period of inactivity or non-use for the purpose of saving power and/or reducing the possibility of unauthorized access by another person if the device was mistakenly left on after use. The length of time of inactivity prior to deactivation (i.e., shut off) may be adjustable in a manner to be described in greater detail below.

Items that may be entered after initially entering the master passcode include lost and found information, creation of preferred user IDs, volume adjustment, auto-off time (i.e., deactivation of the electronic device 10), and contrast level of the display 30. Lost and found information may include the user's information such as name and telephone number on any one of the lines of the display 30.

The preferred user ID may be entered by depressing the desired alphanumeric pushbuttons 18 on the keypad 16 and may be toggled between upper and lower case using the shift button 24 located on the left hand side of the keypad 16 as shown in FIG. 1. Spaces can be entered by pressing the right arrow button 22 if there are no alphanumeric characters 36 located to the right of the cursor 38 on the display 30.

The preferred user ID may be edited at a later time using the options button 60 located on the left hand side of the keypad 16 and then depressing the enter button 52 such that the preprogrammed user IDS are displayed. The user IDs can be edited using the left or right arrow buttons 22 or by moving the cursor to the left side of the string and deleting existing characters and entering the new characters. Depressing the enter button 52 saves the changes to the user IDs.

The user IDs may include various symbols such as the “@” symbol which is accessed by activating the web/e-mail button 64 located at the left hand side of the numeric keypad 16 as shown in FIG. 1. In this regard, the web/e-mail button 64 functions as a multi-tap button to facilitate entry of commonly-used prefixes of web addresses, websites, and e-mail addresses (e.g., “http://, www., @”). Special characters such as symbols and punctuation marks (e.g., “.-_/”) can further be entered using the special characters button 62 shown disposed above the web/e-mail button 64. Domain name extensions (e.g., “.com, .net, .org”). may also be easily added by pressing the multi-tap domain extension button 66 the desired number of times until the desired extension appears.

The user ID may be stored in the memory by pressing the enter button 52 or the down arrow button 22. Other preferred user IDs may be generated and stored in the electronic device 10 using the operation similar to that which is described above. Retrieval of the user IDs at a later date for use in a record 34 may be facilitated by activating or pushing the user ID button 68 located on the upper left hand side of the keypad 16.

The amount of time which passes prior to automatic deactivation or shutting down of the electronic device 10 may be adjusted during the initial setup procedure of the electronic device 10. The display 30 will display 30 an “auto-off mins.:” after which the time period may be adjusted by depressing one of the left and right arrow buttons 22 to change the default setting from one minute to a different setting. The button tone volume may also be changed using the options button 60 to scroll through the various options screen until the “Volume” screen is displayed. The left and right arrow buttons 22 may be depressed in order to select the desired volume level which may then be entered by depressing the enter button 52.

The contrast level of display 30 may be adjusted during the setup procedure of the electronic device 10 by using the options button 60 to scroll to the contrast option on the display and depressing the enter button 52 to select this option. The left and right arrow buttons 22 may be depressed to change the contrast level with up to fourteen being available in a preferred embodiment although any number of levels may be provided. The settings may be stored or saved following each setup options by depressing the enter button 52 on the keypad 16. Additionally, the setup options may be changed at a later time by pressing the options button 60 and resetting the settings in a manner as described above.

Referring briefly to FIG. 1, additional pushbuttons 18 may be located on the right hand side of the keypad 16 as briefly mentioned above. For example, the new button 54 allows for adding new records 34 and storing in the electronic device 10. The edit/delete button 56 facilitates editing of record 34 information previously generated and stored in the electronic device 10. The random password generator button 18 allows for creation of new passwords which may correspond to a previously entered user ID and/or account identification (e.g., a web address, etc.).

Advantageously, the electronic device 10 is configured to allow for the creation of passwords in a random mode, in a manual mode or in a derived mode. The derived passwords may be based upon existing passwords such as random passwords and may be substantially similar thereto. However, the derived passwords may be based on other types of existing passwords such as preprogrammed passwords. Random passwords may be generated to include any variety of alphanumeric characters 36 including numbers and upper and lower case letters and other special characters including symbols and punctuation marks. In a preferred embodiment, passwords may be displayed on the third string 32 of the display 30 although the location of the password may be placed in any order in the vertical stack of strings 32.

In selecting a password for use in a record 34, a random password may be generated each time the random password button 58 is depressed more than 1 time. The edit/delete button 56 may be depressed in order to cancel a random password. Passwords may be modified manually by depressing the edit/delete button 56 or depressing and holding the edit/delete button 56 to delete multiple characters in the random password string 32 after they have been saved. In addition, the electronic device 10 is operative to allow deletion of an entire string 32 or line by pushing and holding the shift button 24 or shift button 24 and depressing the edit/delete button 56.

After entry of each of the strings 32 in the record 34, the record 34 may be stored in the memory by depressing the enter button 52 or the down arrow button 22 prompting the user to again press the enter button 52 to store the record 34 in the memory. Alternatively, the entire record 34 may be deleted in view mode by depressing the shift button 24, depressing the edit/delete button 56 and then depressing the enter button 52.

As was indicated earlier, the electronic device 10 is configured such that unauthorized access to the records 34 stored in the electronic device 10 is prevented following entry of the wrong master passcode. For example, if the master passcode is entered incorrectly into the electronic device 10 more than two times in a row, the electronic device 10 is operative to automatically deactivate (i.e., turn off) and implement a program which increases the length of the time period before additional attempts to enter the master passcode are allowed (i.e., lockout). In this regard, the electronic device 10 increases the lockout period for access to the memory after each successive set of three attempts at master passcode entry although any number of sets of attempts may be programmed into the electronic device 10. Following entry of the correct master passcode, the electronic device 10 may be configured to reset back to the default time delay for entry of the second and additional sets of attempts.

In one embodiment, the electronic device 10 is preferably operative to be placed in the view mode after successful entry of the correct master passcode which then allows the user to scroll through records 34 and perform a variety of other editing and/or display functions. For example, the processor 48 of the electronic device 10 is preferably configured to allow manipulation of the position of the cursor 38 within the display 30 in a variety of operations. The processor 48 may be operative to allow toggling between a top string 32 and a bottom string 32 of a record 34. In a further embodiment, the processor 48 may be operative to allow toggling between a first and last alphanumeric character 36 in any one of the strings 32.

The software and/or processor 48 are configured to allow for insertion of a space before or between a string of alphanumeric characters 36 by pushing and holding the shift button 24 and then depressing the enter button 52. Characters can be inserted by first deleting any characters using the edit/delete button 56 and then entering the new characters. The cursor may be moved to a left side of a string and the edit/delete button 56 can be depressed to delete the desired characters. An entire string may be deleted by moving the cursor to the desire string using the up or down arrow button 22 and then depressing and holding the shift button 24 while depressing the edit/delete button 56 and then depressing the enter button 52.

A user may view the records 34 one-at-a-time by pushing and holding the up or down arrow button 22. Holding the up or down arrow button 22 without releasing causes the records 34 to scroll until the up or down arrow buttons 22 are released. When viewing a record 34 that is located with the middle of a stack of records 34, depressing and holding the shift button 24 causes jumping to the top or first record 34 after pressing the up arrow button 22, or conversely, jumping to the bottom record 34 after pushing the down arrow button 22.

Specific records 34 can be searched by typing in a first character or set of characters of an account identification such as a website name or address stored in the record 34 will cause a prompt to display after which the user may depress the enter button 52 causing the display 30 to jump to the first record 34 starting with the alphanumeric characters 36 or special characters selected. Records 34 may be edited by selecting the edit/delete button 56 allowing the user to modify the website name and/or address, user ID and password of any record 34. As was earlier indicated, cursor 38 location may be manipulated using a combination of the up, down, left and right arrow buttons 22 along with the shift button 24.

For example, pushing the left arrow or right arrow button 22 causes the cursor 38 to move within a current string 32. Pushing and holding the shift button 24 and depressing the left arrow button 22 causes the cursor 38 to jump to the first character of the string 32. Pushing and holding the shift button 24 while pushing the right arrow button 22 causes the cursor 38 to jump to the last character on the string 32. Pushing the up or down arrow button 22 causes the cursor 38 to move line by line. Pushing and holding the shift button 24 while pushing the up or down arrow button 22 causes the cursor 38 to jump directly to the first string 32 or last string 32, respectively. As was mentioned above, characters may be deleted using the left arrow button 22 and then pushing the edit/delete button 56 until the desired characters are deleted. An entire string 32 may be deleted in a single instance by moving the cursor 38 to the string 32 to be deleted and then pushing and holding the shift button 24 and then pushing the edit/delete button 56. Depressing the enter button 52 causes deletion of the entire string 32 of characters while pushing the edit/delete button 56 causes cancellation of the deletion selection after the enter button 52 is depressed.

Records 34 may be deleted in their entirety while in the view mode by pushing and holding the shift button 24 and then pushing the edit/delete button 56. Alternatively, records 34 may be deleted by pushing the edit/delete button 56 to change to “edit” mode allowing deletion of all alphanumeric characters 36 on each of the strings 32 followed by depressing the enter button 52 or the down arrow button 22. The deletion of records 34 change may be saved by pressing the enter button 52 or cancelled by pressing the edit/delete button 56.

With reference to FIG. 5, the electronic device 10 may include a computer-readable storage median which includes thereon a program for executing or performing a method of accessing and displaying records 34 in the electronic device 10. More particularly, the program allows for creating, storing, accessing, retrieving and displaying a plurality of the records 34 in the electronic device 10. As was earlier described, the electronic device 10 may include a data entry mechanism 14 such as a keypad 16, a processor 48, a memory, and a display 30.

A method of operating the electronic device 10 may comprise the steps of creating the master passcode for storage in the memory in the manner described above. As was earlier indicated, the master passcode is preferably 8-15 characters in length and may be comprised of numeric characters that may be entered through the alphanumeric pushbuttons 18. In this regard, during master passcode setup and entry, the alphanumeric pushbuttons 18 have numeric function only (i.e., no alphabetic and no multi-tap function).

Following creating and storing of the master passcode, records 34 may be generated wherein the records 34 comprise the account identification, the user ID, and the password. The records 34 are generated and displayed on the display 30 in the plurality of vertically stacked strings 32. As was earlier mentioned, the account identification may comprise a variety of different types of information including website names and/or addresses, computer or application names, bank names or cell phone names, credit card names, alarm types and/or locations, drivers license and passport numbers as well as other document names, membership program names such as airline frequent flyer program numbers, hotel and car rental royalty numbers, etc.

The user IDs may comprise login IDs/usernames, personal identification number (PIN) codes, credit card numbers, alarm codes, driver's license and passport numbers, account and/or membership numbers as well as a variety of other types of information. Passwords may comprise passwords for websites and computer logins, bank account numbers, three and four digit security codes for credit card numbers, alarm company telephone numbers, expiration dates for drivers license and passport numbers as well as place of issuance for passports, customer service telephone numbers and any other type of information desired.

Following creation of the records 34, the same are stored in the accessible memory of the electronic device 10. A preferred user ID may be generated for use on a frequent basis or which may be slightly altered for different types of accounts. The preferred user ID is stored in the memory and may thereafter be edited for a derived user ID in a manner as described above. Passwords may be generated and may correspond to the manually created user IDs and/or derived user IDs and/or preferred user IDs. Upon successful entry of the master passcode after activating (i.e., turning on) the electronic device 10, the records 34 may be retrieved from memory for display on the display 30 and may thereafter be edited.

Furthermore, additional records 34 may be added to the memory using the above-mentioned procedures. Advantageously, special characters may be added such as symbols and punctuation marks. Web and e-mail address prefixes and suffixes may be conveniently added by manipulation of a plurality of pushbuttons 18 located on the keypad 16. New passwords may be conveniently created for additional accounts using the random password generator button or, alternatively, passwords may be generated manually. The electronic device 10 further allows for retrieval of commonly used or preferred user IDs using the user ID button 68.

The electronic device 10 may be configured as shown in FIGS. 1-4 and may comprise a thin, hollow or shallow dish-shaped housing 12 having the various components (i.e., circuit board 46, processor 48, battery, speaker 50) arranged as shown in FIG. 4. The electronic device 10 may be configured as a generally thin rectangular shaped object and is preferably relatively small in size such as credit card shaped such that a user may conveniently and easily transport and store the electronic device 10. The data entry mechanism 14 may comprise the keypad 16 formed of a plurality of the pushbuttons 18 as described above and having an overlay 20 or graphic overlay disposed thereover and at least in partial contact with the keypad to allow for activation of a desired one of the pushbuttons 18. The overlay 20 may also be configured to protect the interior of the electronic device 10 from the elements.

Additional modifications and improvements of the present invention may also be apparent to those of ordinary skill in the art. Thus, the particular combination of parts described and illustrated herein is intended to represent only certain embodiments of the present invention and is not intended to serve as limitations of alternative devices or functionalities within the spirit and scope of the invention.

What is claimed is:

1. A computer-readable storage medium having stored thereupon a program for performing a method of creating, storing, accessing, retrieving and displaying a plurality of records in an electronic device having a data entry mechanism, a processor, a memory, and a display, the method comprising the steps of:
creating a master passcode;
saving the master passcode in the memory;
creating at least one record including at least one of the following:
an account identification;
a user ID associated with the account identification;
a password associated with the user ID;
saving the record in the memory in encrypted format;
accessing the memory by entering the master passcode;
retrieving one of the records; and
displaying the retrieved record on the display.

2. The method of claim 1 further comprising the step of:
creating the user ID in a manual mode.

3. The method of claim 1 further comprising the steps of:
creating at least one preferred user ID; and
storing the preferred user ID in the memory.

4. The method of claim 3 further comprising the step of:
creating a derived user ID from the preferred user ID.

5. The method of claim 1 further comprising the steps of:
creating a random password; and
storing the random password in the memory.

6. The method of claim 1 wherein the account identification is a web address, the method further comprising the step of:
creating at least one of the account identification and user ID using at least one of a special characters button, a web/e-mail button and a domain extension button.

7. A system for limiting access to a plurality of records, comprising:
a program for creating a master passcode and for creating a plurality of records each comprising at least one of an account identification, a user ID, and a password;
a data entry mechanism for creating the master passcode and the records;
an accessible memory for storing the plurality of records upon entry of the master passcode, the records being stored in the memory in encrypted format; and
a display for displaying the records upon entry of the master passcode;
wherein:
the program is operative to decrypt the records and allow access thereto upon entry of the master passcode;
the program being further operative to cause the display to display the records.

8. The system of claim 7 wherein:
the user ID is created in a manual mode.

9. The system of claim 7 wherein:
the user ID is created in a derived mode;
the derived user ID being based upon an existing user ID and being similar thereto.

10. The system of claim 7 wherein:
the password is created in a manual mode.

11. The system of claim 7 wherein:
the password is created in one of a random mode and a derived mode.

12. The system of claim 11 wherein:
the derived password is based upon an existing password and being similar thereto.

13. The system of claim 11 wherein:
the data entry mechanism includes at least one of a special characters button, a web/e-mail button and a domain extension button for creating at least one of the account identification and user ID.

14. An electronic device adapted for creating, storing, accessing, retrieving and displaying a plurality of records, the electronic device comprising:
a processor configured to be programmed with a master passcode and to allow creation of the plurality of records, each record comprising at least one of an account identification, a user ID, and a password, the password being generated in one of a manual mode, a random mode and a derived mode;
a memory configured to store the plurality of records; and
a display configured to display the plurality of records;
wherein:
the processor is operative to encrypt at least one of the account identifications, the user IDs and the corresponding passwords prior to storing in the memory;
the processor being further operative to decrypt and allow access to at least one of the account identifications, the user IDs and the corresponding passwords for display on the display upon entry of the master passcode at the processor.

15. The system of claim 14 wherein:
the data entry mechanism includes at least one of a special characters button, a web/e-mail button and a domain extension button for creating at least one of the account identification and user ID.

16. The electronic device of claim 14 wherein:
the derived passwords being based upon existing passwords and being substantially similar thereto.

17. The electronic device of claim 14 wherein:
the electronic device includes a plurality of pushbuttons for creating the user IDs and corresponding passwords and allowing editing thereof,
each user ID and password comprising a string of alphanumeric characters;
the display including a movable cursor displayed with the alphanumeric characters of each string;
the display being operative to display at least two vertically-stacked strings including top and bottom strings;
the processor being configured to allow manipulation of the position of the cursor on the display.

18. The electronic device of claim 14 wherein:
the processor is operative to cause the electronic device to shut off after a period of inactivity.

19. The electronic device of claim 18 wherein:
the processor includes the capability to change the length of time prior to shut off of the electronic device.

20. The electronic device of claim 14 wherein:
the processor is configured to operate using an advanced encryption standard (AES) algorithm.

21. The electronic device of claim 14 further comprising:
a housing;
a circuit board disposed within the housing and having a keypad operatively engaged thereto;
an overlay substantially enclosing the housing and contacting at least a portion of the keypad.

22. The electronic device of claim 14 further comprising:
a speaker configured to generate an audible signal corresponding to activation of one of the pushbuttons.
